(19) United States
(12) Patent Application Publication
(10) Pub. No.: US 2025/0178162 A1
(43) Pub. Date: Jun. 5, 2025

(54) RAPID APPROACH SYSTEM FOR HAND TOOLS AND GRIPPING PLIERS

(71) Applicants: Eduardo Garcia Sanchez, Madrid (ES); Manuel Isidro Negreiro, Fort Pierce, FL (US)

(72) Inventors: Maria Luisa Trillo Baigorri, Madrid (ES); Eduardo Garcia Sanchez, Madrid (ES); Manuel Isidro Negreiro, Fort Pierce, FL (US)

(21) Appl. No.: 18/725,847

(22) PCT Filed: Dec. 27, 2022
(86) PCT No.: PCT/ES2022/000051

§ 371 Date: Jul. 1, 2024

(30) Foreign Application Priority Data
Dec. 30, 2021 (ES) P202100125

(51) Int. Cl. B25B 7/12; B25B 7/10; B25B 7/22

(52) U.S. Cl. CPC B25B 7/12; B25B 7/10; B25B 7/22

(57) ABSTRACT

A rapid approach system for tools and gripping pliers is provided that includes a bedplate (1) with a handle (2), a jaw (4), grooves (5), an elongated cavity (3) parallel to the grooves and with a serrated edge (6). A movable jaw (7) moves with respect to the bedplate. A kinematic pair is present between the movable jaw and the bedplate. A movable handle (11) is coupled to the movable jaw (7) and has protrusions with bearing surfaces (13). A spring (16) presses the movable handle (11) against the movable jaw (7). A trigger (14) is coaxial with a shaft (12) where the movable handle (11) also rotates. A stop (15) is rigidly connected to the movable handle that forces the trigger, when the movable handle has not rotated, to be maintained separated from the teeth of the bedplate (25).

### TECHNICAL FIELD

This is a multipurpose tool that replaces pliers, nut wrenches, optionally, shears. Nuts of various sizes can be tightened rapidly, since the regulation is automatic and it can be operated with one hand. It competes with flat ratchet wrenches in that there is no need to remove the wrench from the nut, turn the wrench 60° and refit it (when a nut is being tightened and the angle needs to be restored, simply release the pressure on the handles of the tool, allowing the jaws to open and go around the nut which will be maintained immovable until the next tightening angle). It is also important to emphasise that, unlike what happens with ordinary flat spanners or wrenches, the action is not concentrated in the corners of the nuts because significant pressure is produced on the entire surface of the two faces of the nut. This prevents the nuts from rounding in some cases and prevents the grip from failing in the case of nuts with worn corners.

Three major advantages become apparent when using the tool as pliers:
Some possible embodiments achieve a parallel approach of the jaws.
The force exerted by the jaws can be up to five times greater, depending on the embodiment, than that of conventional pliers of the same dimensions.
Using its particularities (high pressure is available, and the approach can be repeated cyclically), the tool can be converted into shears by coupling blades which may be magnetised to ensure their position once assembled.

### BACKGROUND OF THE INVENTION

This tool is similar to the one published in patent ES 2064565 of Apr. 9, 1989. The similarities in concept are that one of the jaws slides as a result of guides on the main body of the tool containing the other jaw, and that when tightening is to take place, one of the handles of the tool rotates on a movable shaft which has previously been converted into a fixed shaft, and pushes the movable jaw. In both cases it is a tool in which the jaws, after rapidly approaching the part, move slowly, then exerting great force.

The aforementioned tool has been, and still is, a great success in the industry despite the fact that it requires pre-approach manipulation before the gripping of the movable handle. The innovation of the project presented here is that said manipulation is performed automatically, without any conscious intervention by the operator (since the same movement that subsequently presses the part is used initially).

One of the essential and differentiating features of the project is that the bearing surfaces between the movable handle and the movable jaw are positioned below the articulation of the movable handle. This design allows the same direction of the gripping process for the movable handle to be used for the rapid approach of the movable jaw and also, after that, for strong gripping.

### DESCRIPTION OF THE INVENTION

The tool comprises three main portions, see FIG. 1:
1) A part (1), see FIG. 1 which, because it is the largest portion of the tool, will be referred to as bedplate and is formed by:
   a handle (2)
   a central portion comprising grooves (5) and an elongated cavity with a smooth wall (3) and another wall formed by teeth (6),
   one of the jaws of the tool (4).
2) A movable jaw (7) formed by:
   a gripping portion (10),
   a central portion comprising projections (8) that will be housed in the grooves (5) of the bedplate,
   protrusions opposite the gripping portion of the jaw, which are used to couple the head of a movable handle (11) that will push the movable jaw, acting on its bearing surfaces (9).
3) A movable handle (11) with its head drilled to house a shaft (12), formed by protrusions the surfaces (13) of which push the surfaces (9) of the movable jaw.

The tool can be made as traditional pliers, with articulated jaws, maintaining the entire configuration described above, replacing the grooves (5) and projections (8) with bores (5′) and (8′) in which a shaft is inserted, see FIG. 2 and FIG. 25.

### Other Parts Are:

A trigger (14) which, in combination with the teeth (6) of the bedplate, forms a ratchet system. A leaf spring (19) can act on this trigger, see FIG. 5, or a spring housed in a cavity of the trigger (39), see FIG. 30.

A shaft (12) on which the head of the movable handle (11) and the trigger (14) rotate.

A stop (15) rigidly connected to the movable handle that is used to disconnect the trigger from the teeth (8) when the movable handle (11) rotates clockwise, see FIG. 15. A spring (18), see FIG. 4, which presses the movable handle against the bedplate. The tool can be made by replacing the trigger (14) and the teeth (6) with a self-locking cam, see FIG. 3.

Optionally, in order to keep the jaws of the tool open when it is at rest, elastic sheets (33) can be incorporated, see FIG. 28, acting between the handle belonging to the bedplate and the movable handle, or a spring (34), see FIG. 29, acting between the bedplate and the movable jaw.

Another possible embodiment derived from the design of the articulated pliers is to replace one of the jaws with a kinematic chain formed by two parts, making the gripping portion of the jaw articulated. This portion (44) is extended, creating an end (46), diametrically opposed to the gripping area, see FIG. 33, for the purpose of it resting on the other arm of the tool (47). The bearing surfaces are designed with circular arcs to ensure that the two jaws of the tool are maintained parallel.

Optionally, the gripping portion of the jaw can be made disengageable for the purpose of being able to use different configurations, see FIG. 33, depending on whether you nuts are to be tightened, tubes pressed, wires cut, etc. Their bearing areas can be slightly magnetised to ensure contact between the bearing surfaces.

The gripping profile of the jaw (44) consists of a flat portion, which will be maintained parallel to the other jaw, and a notch-shaped area, closer to the articulation. This configuration allows nuts to be handled, see FIG. 33, and also allows tubes to be tightly held, see FIG. 34.

In the event that the gripping portion of the second jaw, belonging to the bedplate, is also articulated, a symmetrical configuration is achieved, see FIG. 35. The bearing surfaces (48) and (49) are designed so that the jaws are maintained parallel.

When the movable handle descends from its initial position, in all the configurations described heretofore, the trigger accompanies the rotation until it collides with the teeth of the bedplate: if the trigger rotates, for example, ten degrees to go from the open to the closed position, these same ten degrees will have rotated the movable handle. The device described below reduces these ten degrees, which are unusable for pressing, to less than two.

It consists of a crank (37) that rotates in a bore (38) made in the trigger, close to its shaft. A pre-compressed spring (39) positioned between the crank and trigger ensures permanent contact between the end (40) of this crank and the smooth portion of the cavity of the bedplate. The crank consists of a side stop (41), positioned between its end and its articulation, which is pushed by an area (42) of the movable handle of the tool when it reaches its maximum opening, causing the crank to pivot on its end (40) and lift the trigger. A very small movement of the stop (41), see FIG. 32, is enough to place the crank (37) against the bedplate and, accordingly, cause the full movement of the trigger.

Method of assembly:
The movable handle and the movable jaw are positioned so that they are in the same plane, see FIG. 4, coupling, in the cavity of the movable jaw, the head of the movable handle, and placing its surfaces (13) in contact with the surfaces of the movable jaw (9). The parts are attached to one another by means of the spring (16), for which the ends thereof are forced to separate from one another and are introduced into the bore of the movable handle (17) and into the bore (18) of the movable jaw. When the spring is closed again, the movable handle remains attached to the movable jaw in the position shown in FIG. 4. As long as the spring does not give way, the assembly behaves as a single kinematic link. The trigger (14) is positioned in the cavity of the bedplate, see FIG. 5, and then the assembly, formed by the movable handle and the movable jaw, slides into the groove (5) of the bedplate, see FIG. 6. Then the shaft (12) is assembled by inserting it into the bores in the handle and trigger. The assembly is completed by incorporating the stop (15) in the movable handle, see FIG. 7, for which the movable handle must previously be rotated downwards. After inserting the stop, when the movable handle returns to the initial position forced by its spring (18), the trigger is separated from the bedplate, allowing the movable jaw to move in both directions.

As long as the spring (18) cannot be overcome, the assembly formed by the movable jaw and the movable handle behave as a single rigid part.

### Operation:

When applying a couple of forces (20) and (21), see FIG. 8, in the upper portion of the handles, the assembly formed by the movable jaw and the movable handle behaves as a single part maintained rigid due to the pressure of the spring (16). As there is little friction in the groove, the entire assembly moves until its jaw abuts with the object (22), see FIG. 9, to be pressed. If the force continues to be increased, the spring (18) can be opened, see FIG. 10, and the movable handle starts to rotate. Accordingly, the stop (15) that maintained the trigger elevated begins to move and allows the trigger to descend.

During a small angle, the movable handle that is in contact with the movable jaw causes a backwards movement of the shaft (12) and accordingly the trigger retracts until the coupling (23) of its teeth with those of the bedplate occurs, see FIG. 11, then being immobilised. The shaft (12) now is now converted into a fixed shaft on which the movable handle rotates, allowing its protrusions (13), see FIG. 12, develop a large force on the movable jaw (9). For the equilibrium of moments to which the movable handle is subjected with respect to its shaft, see FIG. 27, it can be deduced that this force is more than 10 times greater than the force exerted by the operator. The force, see FIG. 12, transmitted through the movable jaw, causes the deformation of the object (22) to be pressed. Process can continue, see FIG. 13, until the ends of the handles touch. To release the part, the opening of the movable handle begins, which causes a clearance (24) between the teeth, see FIG. 14. Then the stop (15) rigidly connected to the lever comes into contact with the trigger, lifts it, leaving a clearance (25), see FIG. 15, and positioning it out of reach of the teeth of the bedplate, which allows the jaws to be opened, moving the entire assembly, movable handle and movable jaw to the initial position, see FIG. 8.

### BRIEF DESCRIPTION OF THE DRAWINGS

Said description is accompanied by a set of drawings constituting an integral part thereof in which, by way of illustration and not limitation, the following has been depicted:

FIG. 1 shows the essential parts of the project.

FIG. 2 shows the embodiment of the tool as pliers, replacing the grooves (5) and projections (8) with an articulation with bores (5′) and (8′).

FIG. 3 shows the possible replacement of the trigger and teeth with a self-locking cam.

FIG. 4 shows the movable jaw and the movable handle in the assembly process, and how, once attached by the spring, they behave as a single rigid solid as long as the spring does not give way.

FIG. 5 shows the assembly formed by the movable jaw and the movable handle, arranged to be coupled in the bedplate (1) sliding through the groove (5). The trigger (14) has previously been placed in the cavity of the bedplate (1).

FIG. 6 shows the continuation of the assembly started in FIG. 5. The movement of the movable jaw (7) has been stopped so that the bore of the movable handle and the bore of the trigger are aligned, and the common shaft (12) is inserted. The stop (15) of the trigger is not yet coupled.

FIG. 7 shows the stop (15) of the trigger coupled and the trigger raised, forced by the stop.

FIG. 8 shows the tool that is going to start to close under the action of the external forces (20) and (21) produced with the operator's index finger and thumb.

FIG. 9 shows the tool that has come into contact with the part to be pressed (22).

FIG. 10 shows the beginning of the rotation of the movable handle and the trigger beginning to descend, forced by the action of its spring (19), and rotating at the same time as the movable handle.

FIG. 11 shows the coupling (23) of the trigger with the teeth of the bedplate and, accordingly, the immobilisation of the shaft (12).

FIG. 12 shows the pushing produced by the surface (13) of the protrusions of the movable handle on the surface (9) of the movable jaw.

FIG. 13 shows how the movable jaw has moved and how its jaw has deformed the tube (22).

FIG. 14 shows how, when the movable handle is raised, the trigger is raised, pushed by the stop (15), and stops horizontally pressing the teeth of the bedplate (24).

FIG. 15 shows how the stop (15) lifts the trigger, producing a clearance (25) that now allows the movable jaw to slide to prepare the tool for another operation.

FIG. 16 shows three views of a trigger designed to work together with a second trigger depicted in the FIG. 17).

FIG. 17 shows three views of a trigger designed to work together with the first trigger depicted in the FIG. 16).

FIG. 18 shows how the previous triggers are assembled coaxially. The articulation of the surrounding trigger has more clearance (28) than that of the inner trigger.

FIG. 19 shows how, in this case, contact is established with the inner trigger.

FIG. 20 shows a position in which neither of the two triggers is acting.

FIG. 21 shows a position in which the outer trigger is acting. Due to the clearance of its shaft, the force is transmitted through the inner trigger as a result of the support of the surfaces (26) and (27).

FIG. 22 shows how, in order to convert the tool into shears, attachments are assembled, the fixing of which can be magnetic (29).

FIG. 23 shows how, as a result of bores (30) made in the bedplate and the movable jaw and with the help of a pin (31), the jaws can be prevented from retracting.

FIG. 24 shows the similarity between the embodiment of the tool with parallel jaws and the articulated pliers.

FIG. 25 shows the embodiment as pliers with another arrangement of the spring (16″) and with a ratchet (32) preventing the jaw from retracting.

FIG. 26 shows a crank (37) that presses a spring housed in the trigger.

FIG. 27 shows, considering the equilibrium of moments acting on the movable handle with respect to the fixed shaft, that the force acting on the part is, in this embodiment, about 14 times greater than that exerted by the operator.

FIG. 28 shows leave springs (33) acting between the handles, which maintain the pliers open when it is at rest.

FIG. 29 shows a flat coil spring (34) anchored in a bore made in the movable jaw (36) and another one made in the bedplate (35) to maintain the pliers open when it is at rest.

FIG. 30 shows the tool in operation with the trigger (14) engaged with the teeth of the bedplate (23), and the bearing surface of the movable handle (13) pushing.

FIGS. 31 and 32 describe an optional configuration, which lifts the trigger with a very small rotation of the movable handle. The trigger and a small crank (37) are shown. The crank compresses a spring (39) and rotates with the bore (33). The essential difference with FIG. 26 is that the crank is provided with side projections (41) that will be pushed by the movable handle.

FIG. 32 shows on the right side how the end (40) of the crank is in contact with the bedplate due to the action of the spring. On the left side, the crank is shown placed against the edge of the bedplate due to the pushing of the movable handle acting with its surface (42) on the projection (41) of the crank. The trigger is disengaged.

FIG. 33 shows the embodiment of the project as pliers with one of its jaws that allows the gripping portions to be exchanged, according to the task performed. It can be observed that the gripping portion (44) rests on the surface of the bedplate (47)

FIG. 34 shows the tool holding a tube with the dual-purpose gripping portion (44) also suitable for handling nuts, as seen in FIG. 33.

FIG. 35 shows the embodiment of the project as symmetrical pliers, making the two jaws articulated and resting on the surfaces of opposite links (43) and (49)

### PREFERRED EMBODIMENT OF THE INVENTION NO. 1

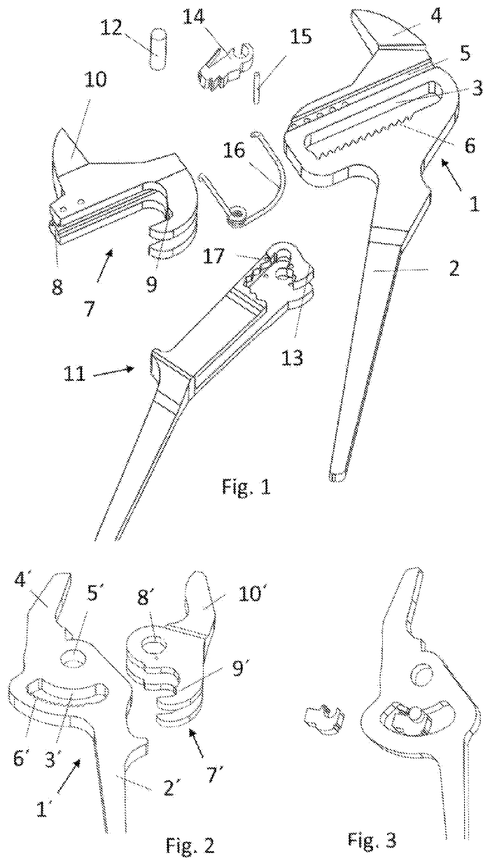

The tool, see FIG. 1, is made using three main components: the bedplate (1), the movable handle (11) and the movable jaw (7).

The bedplate is formed by: a handle (2), one of the jaws of the tool (4) and a central area. Said area comprises grooves (5) and an elongated cavity with a smooth wall (3) and another wall formed by teeth (6).

The head of the movable handle is formed by protrusions the surfaces (13) of which will push the surfaces (9) of the movable jaw. Said protrusions are drilled to house a shaft (12) on which a trigger rotates.

The movable jaw (7) comprises a central area with projections (8) which will be housed in the grooves (5) of the bedplate, the gripping area of the jaw of the tool (10), and protrusions opposite the gripping area which are used to couple the head of the movable handle (11) which will push the movable jaw.

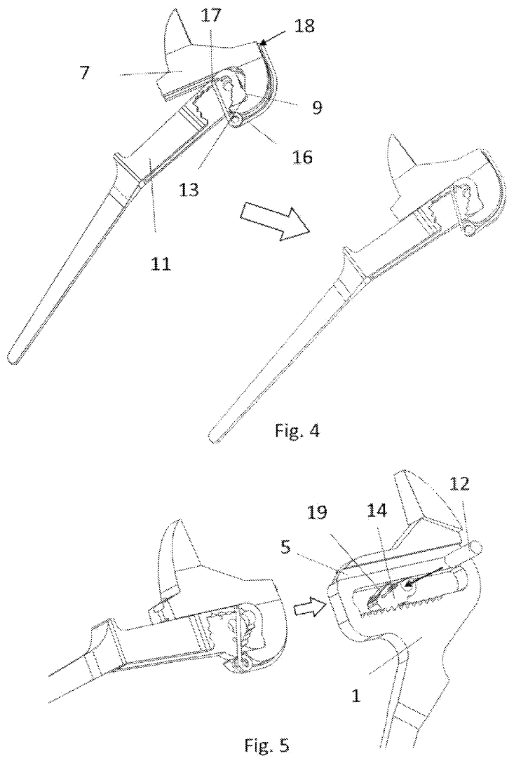

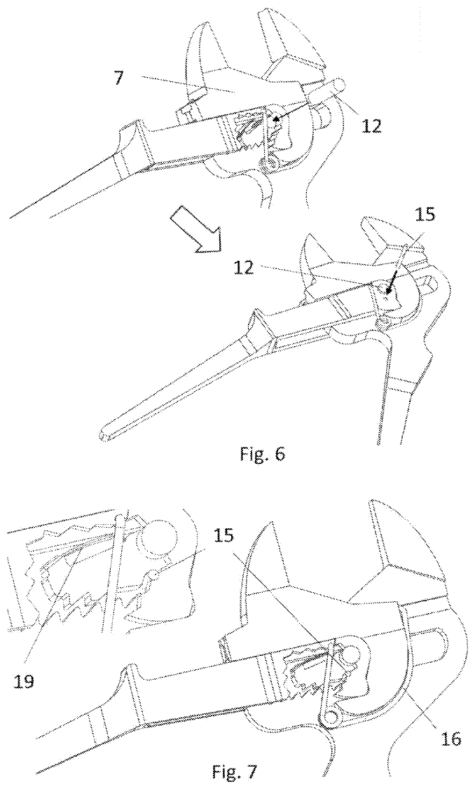

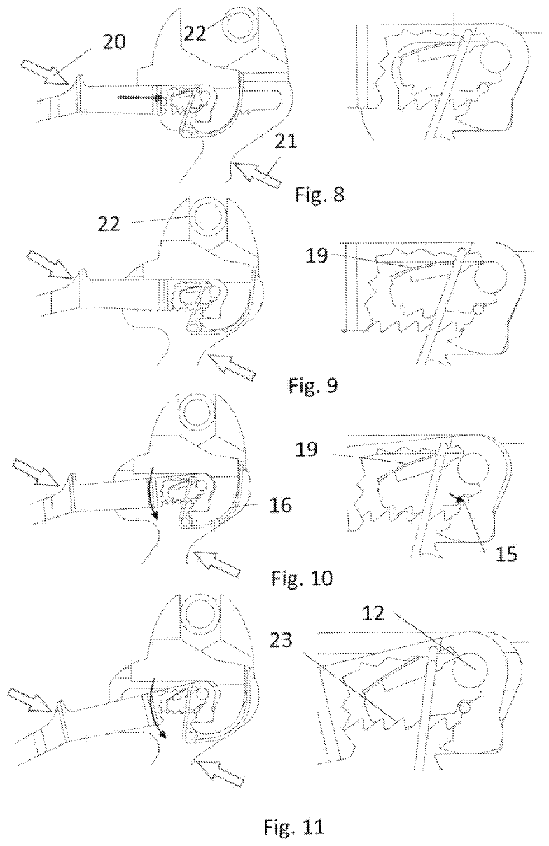

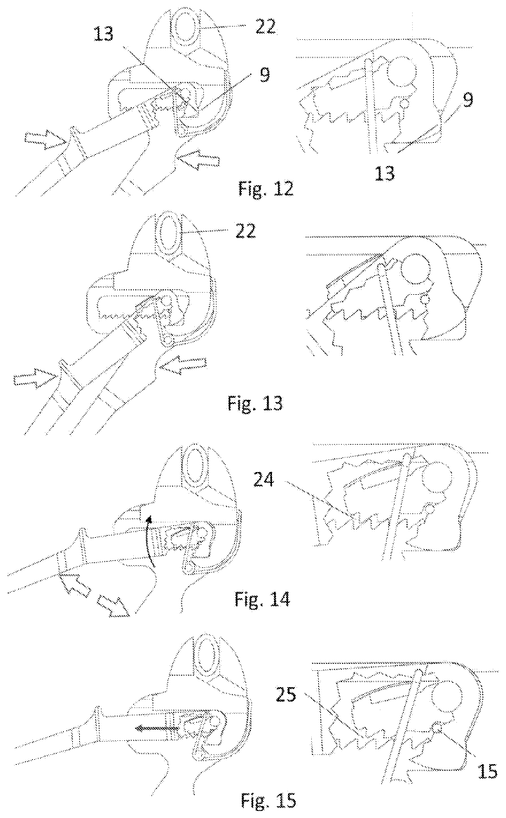

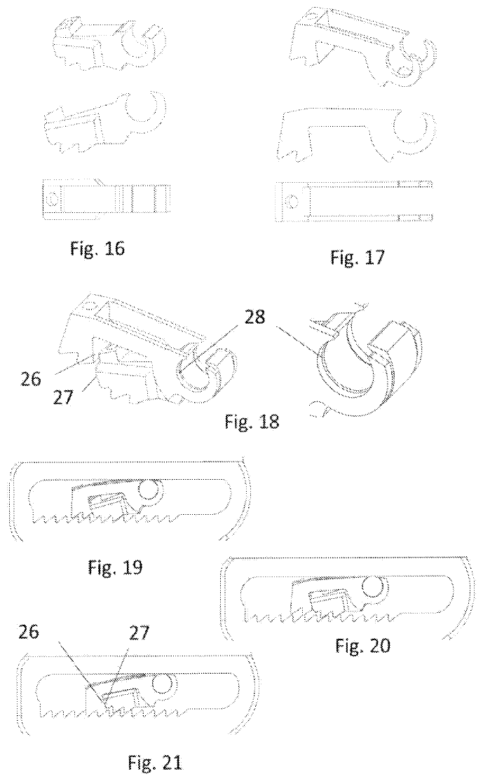

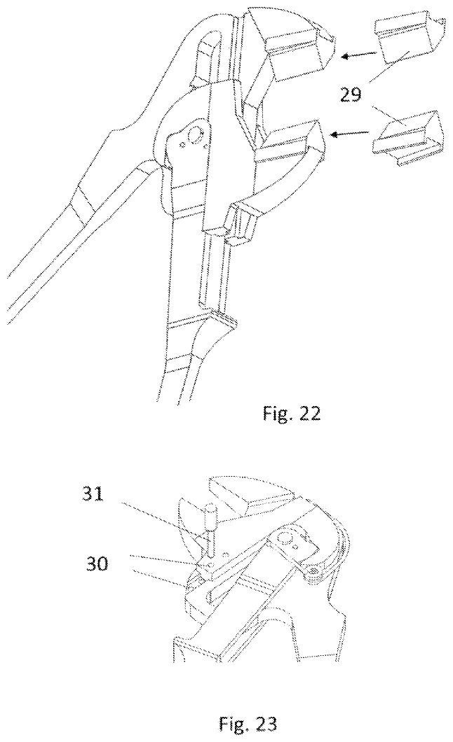

The movable handle is coupled in a cavity of the movable jaw, attaching it by means of a spring (16), see FIG. 4. As long as the spring does not give way, this assembly behaves as a single kinematic link and has a single degree of freedom with respect to the bedplate due to some projections (8), see FIG. 1, which slide into the grooves (5). A trigger is positioned, which trigger has a leaf spring coupled to same that rests on the smooth portion of the elongated cavity of the bedplate, always trying to cause its coupling with the teeth made on the lower edge of the cavity in the bedplate. The articulations of the movable handle and the trigger are concentric, sharing the shaft (12), see FIG. 6.

There is assembled a stop (15), see FIG. 7, rigidly connected to the movable handle that maintains the trigger raised to initially prevent it from making contact with the teeth of the bedplate.

The distance from the rotation shaft of the movable handle (which shaft is converted into a fixed shaft when the trigger is engaged) and the bearing surface (13) in contact with the movable jaw become very small in order to obtain a great force acting on the movable jaw, as deduced considering the equilibrium of moments of the movable handle with respect to its shaft, see FIG. 27.

### PREFERRED EMBODIMENT OF THE INVENTION NO. 2

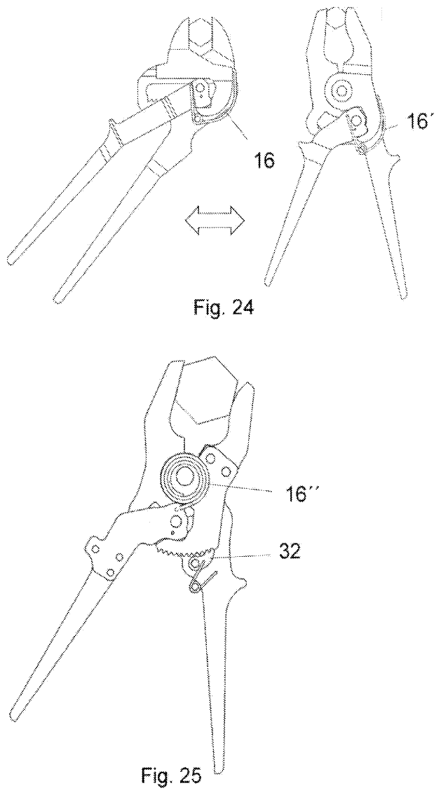

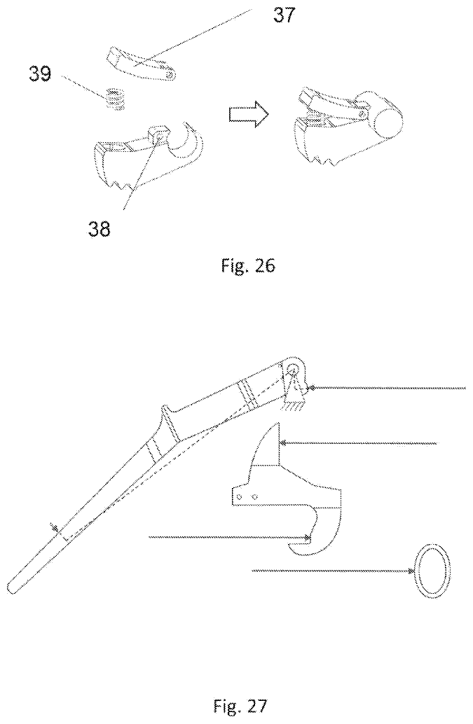

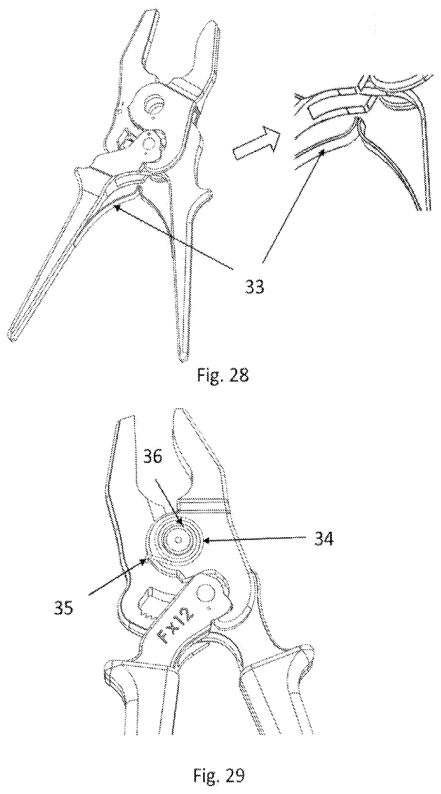

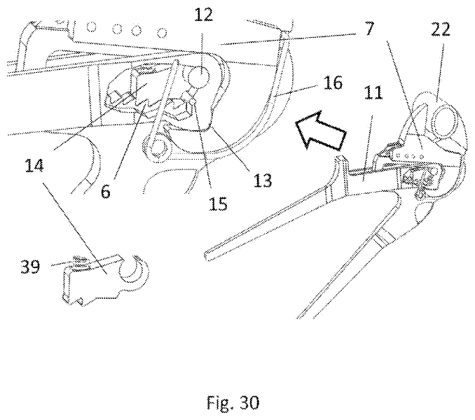

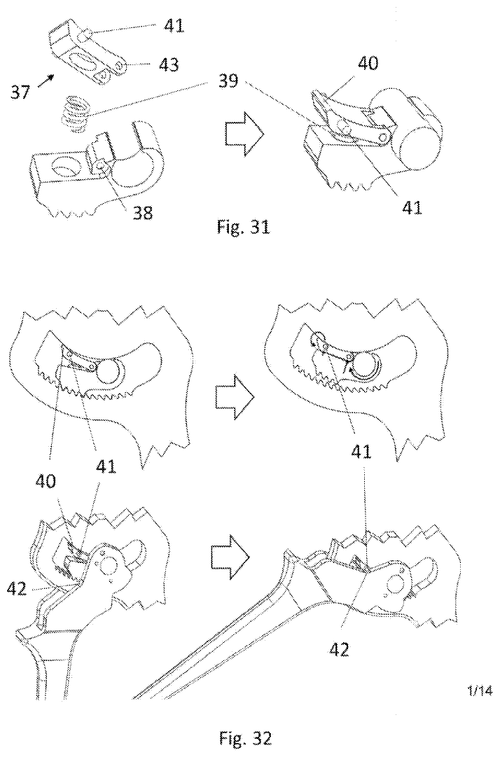

The embodiment as pliers, see FIG. 26, is similar to preferred embodiment no. 1, as becomes apparent in FIG. 24, with the only exception being that the movable jaw is not a sliding jaw, but rather rotates on a shaft housed in a bore (5′) which replaces the previous groove (5) of the bedplate. The cavity (3) that was straight in embodiment no. 1 is, in this case, curved (3′), concentric with the shaft of the jaws.

Additionally, a ratchet (32) which prevents the movable jaw from retracting has been incorporated, see FIG. 25. This option is useful when an elastic material is to be compressed or the system is to be used to make shears. It allows the movable handle to be opened again without losing the ground gained, causing the trigger to engage in the next tooth of the bedplate, which causes a movement of the shaft of the movable handle. This allows the movable handle to be closed again and compression or cutting to continue.

### PREFERRED EMBODIMENT OF THE INVENTION NO. 3

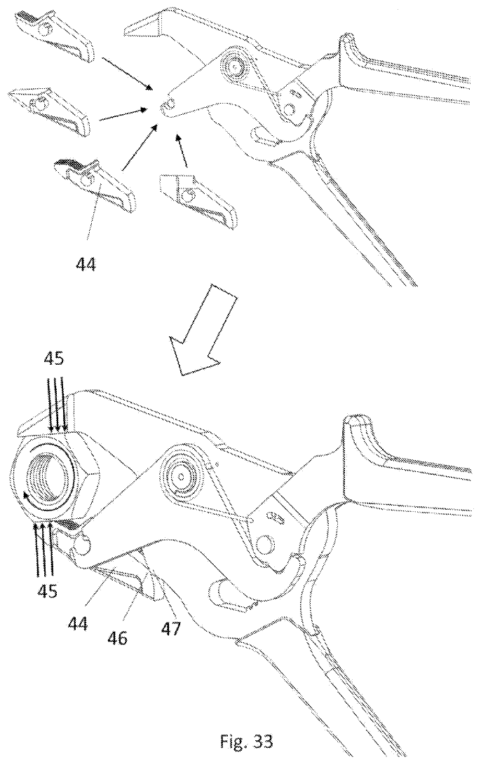

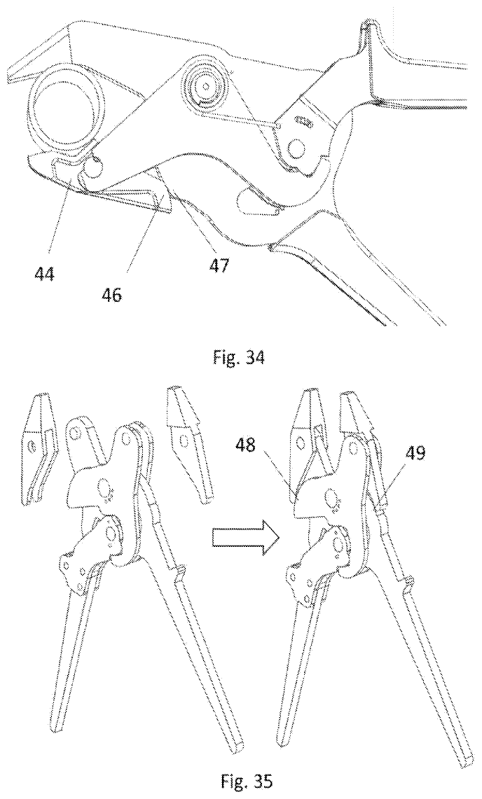

This embodiment, shown in FIG. 33, is based on preferred embodiment no. 2. It shows articulated pliers with the advantage of maintaining the jaws thereof parallel. This is achieved by dividing the movable jaw into two portions attached by an articulation. The rotation of the gripping portion is limited by providing it with an extension that rests on a curved surface of the contiguous link, which is the bedplate in this case.

In order to make the tool more versatile, several gripping portions are designed, depending on whether nuts are to be tightened, tubes held, materials cut, etc.

These parts are slightly magnetised in order to guarantee contact with the bearing surface.

1. A rapid approach system for tools and gripping pliers, comprising:
a bedplate (1) comprising a handle (2), a jaw (4), grooves (5), an elongated cavity (3) parallel to the grooves and with a serrated edge (6),
a movable jaw (7) that can move with respect to the bedplate, comprising a gripping portion (10), extensions opposite the gripping portion with bearing surfaces (9),
a kinematic pair between the movable jaw and the bedplate, comprising a slide formed by projections (8) incorporated in the movable jaw and a groove (5) belonging to the bedplate,
a movable handle (11) that is coupled to the movable jaw (7) and has protrusions with bearing surfaces (13) that are maintained in contact with the bearing surfaces (9) of the movable jaw (7),
a spring (16) which presses the movable handle (11) against the movable jaw (7) and which, in the absence of external forces, converts the assembly into a single rigid kinematic link,
a trigger (14), coaxial with a shaft (12) where the movable handle (11) also rotates, which, under the action of a pre-compressed leaf spring, (19) or coil spring (39), tends to rotate and engage (23) with the teeth of the bedplate,
a stop (15) rigidly connected to the movable handle that forces the trigger, when the movable handle has not rotated, to be maintained separated from the teeth of the bedplate (25), and characterised:
in that the shaft (12) of the movable handle is positioned below the jaws and above the bearing surfaces (13) of the movable handle and the bearing surfaces (9) of the movable jaw,
in that the movable handle and the movable jaw are attached to one another by a spring sufficiently rigid to initially maintain the assembly rigid, as a single rigid solid, which, under the force exerted by the operator, moves with respect to the bedplate until its jaw touches the object to be pressed,
in that once the object to be pressed is touched, the spring gives way, starting the rotation of the handle, causing the stop rigidly connected to the handle to descend and release the trigger which, pushed by its spring, engages with the teeth of the bedplate and becomes immobilised (23), causing its shaft, which it shares with the movable handle, to be converted into a fixed shaft,
in that when the shaft of the movable handle is fixed and a force continues to be applied to the movable handle, the spring is forced to open more and the rotation of the movable handle resumes, causing its protrusions (13), which are in contact with the movable jaw, to push it, and
in that when the operation is completed and the movable handle is opened, the trigger is lifted by the stop (15) belonging to the movable handle and stops pressing the teeth of the bedplate, the movable jaw then being unlocked.

2. The rapid approach system for tools and gripping pliers, comprising the elements and features according to claim 1 except for the slide, which is replaced with an articulation consisting of a bore (5′) made in the bedplate and another bore (8′) in the movable jaw, joined by a common shaft, and designing the toothed cavity (3) with a circular shape (3′), being concentric to the articulation.

3. The rapid approach system for tools and gripping pliers according to claim 1, characterised in that the trigger and teeth of the bedplate are optionally replaced with a self-locking cam acting on a smooth or rough surface, designed so that the segment that joins its shaft with the bearing area forms with the perpendicular to the surface an angle less than the angle the tangent of which is the coefficient of friction.

4. The rapid approach system for tools and gripping pliers according to claim 1, characterised:
in that the articulations of the large trigger have a slight clearance (28), ensuring that the force exerted by a tooth of the bedplate on the large trigger is transmitted, as a result of the contact between the internal surface (26) of the large trigger and the surface (27) of the end of the small trigger, through the latter.

5. The rapid approach system for tools and gripping pliers according to claim 1, characterised in that blades (29), are coupled in the jaws, acting as shears.

6. The rapid approach system for tools and gripping pliers according to claim 1, characterised in that it has a ratchet (32) or a pin (31) that is manually inserted into bores (30) made in the bedplate and in the movable jaw, preventing the jaws from retracting.

7. The rapid approach system for tools and gripping pliers according to claim 1, characterised in that the spring, which is a leaf spring (19) or coil spring (39), acting on the trigger rests, directly or through an intermediate part (37), on the smooth surface of the cavity opposite the teeth of the bedplate, this intermediate part being a small crank articulated in the trigger near its shaft and extending towards its end.

8. The rapid approach system for tools and gripping clamps according to claim 2, characterised in that, at least one of the ends (44) of the jaws are articulated, elongating these parts from their articulation in the opposite direction with respect to the gripping portion with extensions (46) that rest on surfaces (47) of the adjacent links of the tool, ensuring that the gripping areas of the jaws are maintained parallel.

9. The rapid approach system for tools and gripping pliers according to claim 1, characterised in that it uses a kinematic chain to rapidly release the trigger(s), the kinematic chain comprising the crank (37) that pivots in a bore (38) made in the trigger, close to its shaft, with a pre-compressed spring (39) positioned between the crank and trigger ensuring permanent contact between the end (40) of the crank and the smooth portion of the cavity, the crank consisting of a stop (41), located between its end and its articulation, which is pushed by an area (42) of the movable handle of the tool when it approaches its maximum opening, causing the crank to pivot on its end (40) and lift the trigger.

10. The rapid approach system for tools and gripping pliers according to claim 1, characterised in that the articulation of the movable handle uses a shaft (12) the central area of which is in contact with the bedplate and is positioned below the jaws and above the bearing surfaces of the movable handle (13) and the bearing surfaces of the movable jaw (9).

11. The rapid approach system for tools and gripping pliers according to claim 2, characterised in that it comprises two concentric triggers with offset teeth which share the shaft of the handle, the longer trigger consisting of a body containing the teeth and extensions attaching it to the shaft and leaving an inner space to house the second smaller trigger.

12. The rapid approach system for tools and gripping pliers according to claim 5, characterised in that blades (29), are magnetised.
